(19) United States
(12) Patent Application Publication
(10) Pub. No.: US 2006/0130140 A1
(43) Pub. Date: Jun. 15, 2006

(54) System and method for protecting a server against denial of service attacks

(75) Inventors: Dmitrii Andreev, Port Chester, NY (US); Luu Quoc Nguyen, Culver City, CA (US); Gregory Vilshansky, Chappaqua, NY (US)

Correspondence Address: Shelley M Beckstrand;Patent Attorney, 61 Glenmont Road, Woodlawn, VA, 24381-1341, US

(73) Assignee: International Business Machines Corporation, Armonk, NY (US)

(21) Appl. No.: 11/011,654

(22) Filed: Dec. 14, 2004

(51) Int. Cl. G06F 12/14

(52) U.S. Cl. 726/23

(57) ABSTRACT

A client application server includes a client server, a proxy authentication server, and an authentication server. The proxy authentication server maintains a set of one or more authentication rules and an authentication request table. The client server is responsive to an authentication request from a user including a user identifier for directing the authentication request to the proxy authentication server for searching the authentication request table for entries for the client; responsive to finding one or more entries, applying the filter rules; responsive failing a filter rule, rejecting the authentication request in a response message to the client server; and responsive to passing all relevant filter rules, directing the authentication request to the authentication server for authenticating the user.

### BACKGROUND OF THE INVENTION

1. Technical Field of the Invention

This invention relates to protecting a server against multiple login denial of service attacks.

2. Background Art

If a hosted web application allows multiple simultaneous logins under the same user's credentials, and the user session created upon login consumes considerable system resources, such as memory, a denial of service attack might be possible by running a simple script performing multiple user logins. The application can be brought to a non-responsive state for the duration of the session inactivity timeout, which is usually in the range from several minutes to several tens of minutes.

Managers of information systems for public and private enterprises are required to provide ever increasing network access to their information systems. As business requirements for connection to the Internet grow, system security concerns increase in lock step.

The current art for network and system security, which uses TCP/IP socket protocol and firewall technology does not provide complete protection for an organization's systems. Internet connected systems have an exposure to jamming by anyone with an Internet-connected computer. Some computer systems are designed for public access, and must be available to members of the public desiring and authorized to access them. This leaves the systems of Internet-connected organizations open for attacks, including jamming attacks known as denial of service (DOS) attacks or distributed denial of service (DDOS) attacks, in which streams of traffic are directed at an organization's Internet-connected systems.

Initially, DOS attacks came from individual machines from which individual hackers streamed data (e.g., ping echo packets) to web-attached servers in an effort to flood the network and burden the server with the overhead of handling the stream of data.

Today, hackers have learned how to take control of or “borrow” multiple web-attached computers in different organizations (“masters”), use these master machines to infiltrate many more computers in different organizations (“zombies”), embed DOS attack code scripts (or, “trojan-horses”) in the zombies through the masters, and then issue commands from the masters to the zombies to run the scripts directed at the server(s) of a targeted organization.

The hackers, twice removed from the attacking zombie machines, are difficult to trace. The attacks coming from many different zombies in many different networks comprise DDOS attacks that are hard to detect and control. The scripts run by the zombies are a nasty assemblage of echo packet floods, status requests, incomplete logins, deliberate causes of connection error conditions, false reports of errors, and transmissions of packets requiring special handling. Many of these zombies may occur at and are received at the application level. These vicious scripts, run from hundreds or thousands of zombies, are designed to flood the network, tie up system control blocks, and siphon web server computing power to the point that the attacked webserver network and system can no longer provide service to legitimate users. All the while, the zombie computers causing the damage are owned by legitimate organizations which have no idea that their systems are being used in attacks on other organizations.

### SUMMARY OF THE INVENTION

A system, method and program storage device are provided for protecting a server against a multiple-login denial of service attack by providing a proxy authentication server having an authentication request history table; maintaining in the table recent authentication requests to a second server, including user ID and time of each of the recent authentication requests; receiving a subsequent authentication request at the proxy authentication server; and determining whether to forward the subsequent authentication request to the second server based on a pre-defined filtering rule(s) and the user ID and time of authentication request in the authentication request history table.

In accordance with an aspect of the invention, there is provided a computer program product configured to be operable to protect a server against a multiple-login denial of service attack by providing a proxy authentication server having a authentication request history table; maintaining in the table recent authentication requests to a second server, including user ID and time of each of the recent authentication requests; receiving a subsequent authentication request at the proxy authentication server; and determining whether to forward the subsequent authentication request to the second server based on a pre-defined filtering rule and the user ID and time of authentication request in the authentication request history table.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a diagrammatic representation of the OSI architecture.

FIG. 2 is a high level system diagram illustrating major components of the invention.

FIG. 3 is a system diagram illustrating the proxy authentication server of a first preferred embodiment of the invention.

FIG. 4 is a system diagram illustrating the proxy authentication server of a second preferred embodiment of the invention.

FIG. 5 illustrates the format of an authentication (bind) request.

FIG. 6 illustrates the format of an authentication (bind) response.

FIG. 7 illustrates the format of a referral response, or result.

FIG. 8 is flow chart representation of a first exemplary filtering rule.

FIG. 9 is a flow chart representation of a second exemplary filtering rule.

FIG. 10 is a flow diagram illustrating the operation of an exemplary embodiment of the proxy authentication server of the invention.

FIG. 11 is a high level system diagram illustrating a program storage device readable by a machine, tangibly embodying a program of instructions executable by a machine to perform operations for protecting an application server against multiple login denial of service attacks.

### DETAILED DESCRIPTION OF PREFERRED EMBODIMENTS

A system, method and program storage device are provided for protecting a server against a multiple-login denial of service attack by providing a proxy authentication server having an authentication request history table; maintaining in the table recent authentication requests to a second server, including user ID and time of each of the recent authentication requests; receiving a subsequent authentication request at the proxy authentication server; and determining whether to forward or redirect the subsequent authentication request to the second server based on a pre-defined filtering rule and the user ID and time of authentication request in the authentication request history table.

The present invention is implemented in application layer. That is, the present invention limits the number of login attempts to a hosted application using legitimate user credentials, thus providing protection from application level denial of service attacks using a typical HTML browser and application level authentication and authorization.

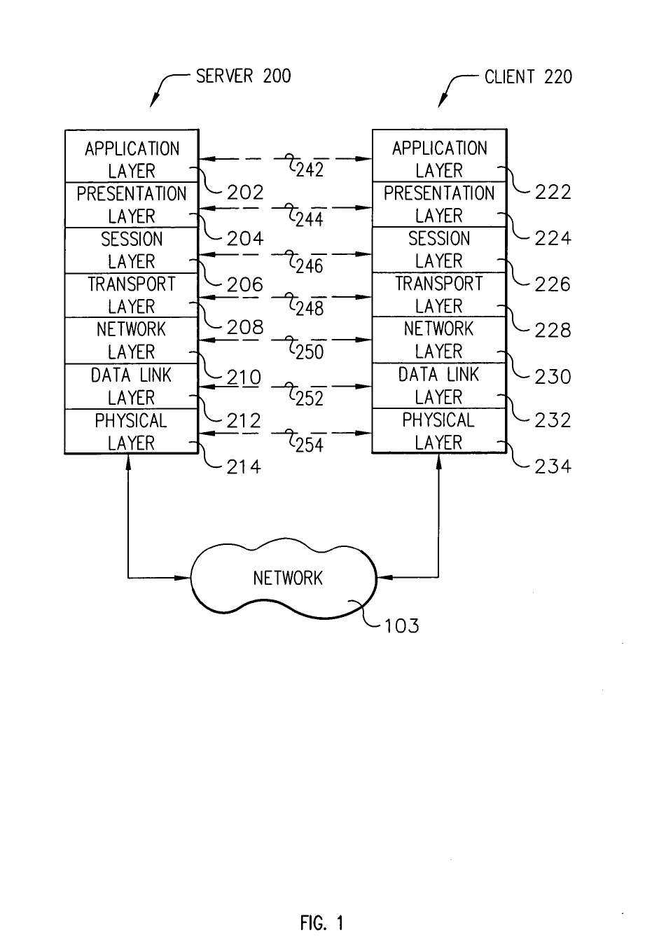

Referring to FIG. 1, the open system architecture (OSA) model represents a network as a hierarchical structure of layers of functions; each layer providing a set of functions that can be accessed and that can be used by the layer above it. Layers are independent in the sense that implementation of a layer can be changed without affecting other layers. According to the open systems interconnection standard of the International organization for Standardization (OSI), that network functions are divided into seven layers: application layer 202, 222, presentation layer 204, 224, session layer 206, 226, transport layer 208, 228, network layer 210, 230, data link layer 212, 232, and physical layer 214, 234. It is a characteristic of systems architected to the OSI model that each layer of a server 200 logically communicates with, and only with, corresponding layers of client 220. As represented by line 242, application layer 202 is in logical connection to (only communicates with) application layer 222. Similarly, lines 244-254 represent logical connection of layers 204-214 with respective layers 224-234.

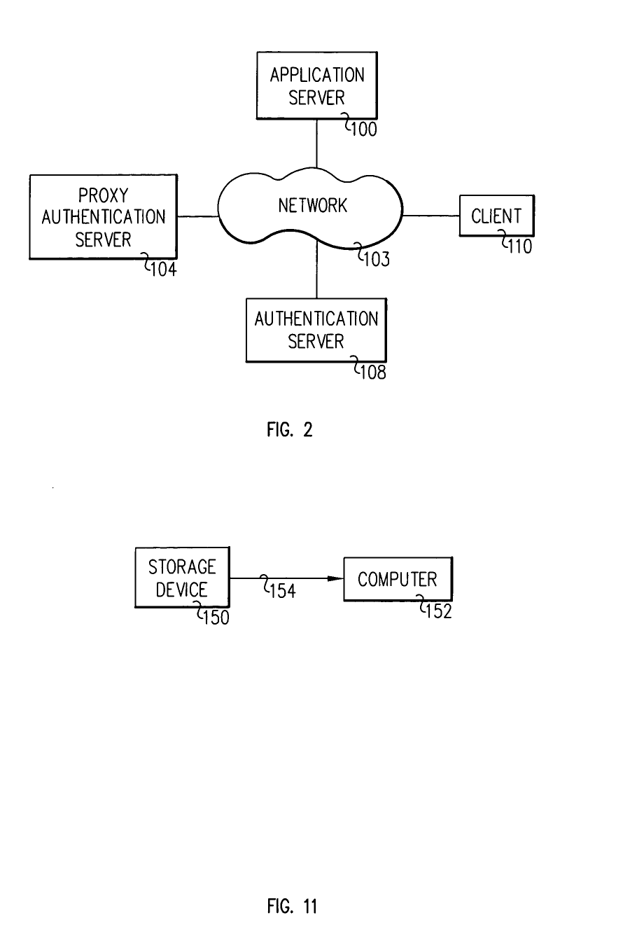

Referring to FIG. 2, proxy authentication server 104 is placed on a machine on the network 103 where application server 100 and server 108 reside, or on another network interconnected with network 103.

Proxy authentication server 104 is a software module that intercepts communication between a application code 101 (or client module) and a server module 108, and while being transparent to both client module 101 and server module 108, is capable of either passing requests and response through, or performing additional processing and/or modifications of requests and/or responses.

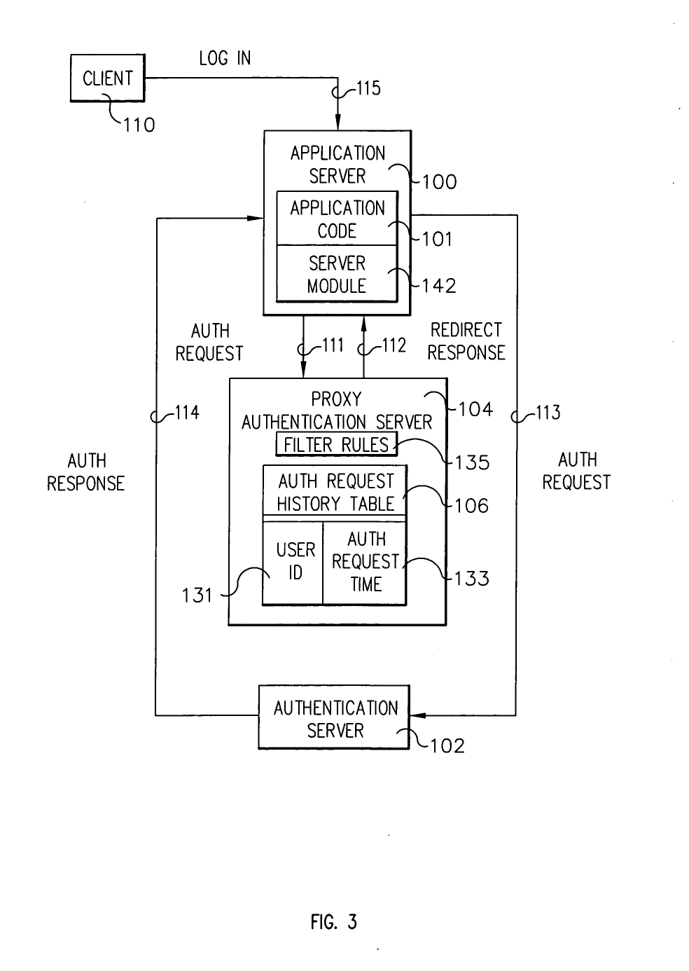

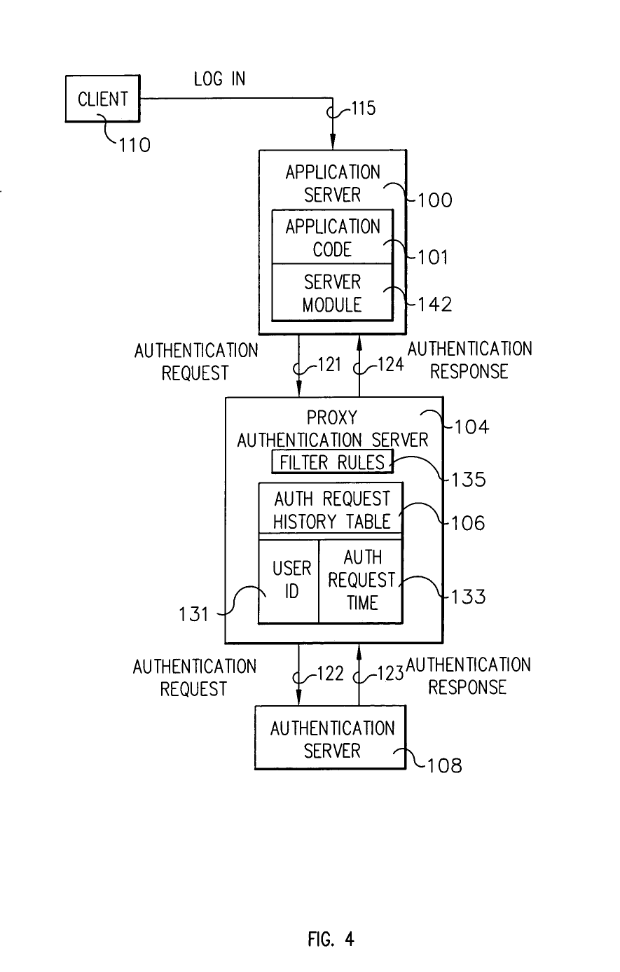

Referring to FIGS. 3 and 4, two preferred embodiments are illustrated. In these embodiments, application code 101 runs on server 100. In situations when application code 101 cannot be changed to accommodate protective measures, or when such a change is undesirable for whatever the reason may be, an external protection mechanism is provided by proxy authentication server 104, the purpose of which is to limit the number of login attempts for any given user ID within a specified time frame, thus preventing a malicious party possessing a valid user credential for application 101 from launching a multiple-login denial of service attack.

A user credential is a <username, password> pair that is unique across a given domain, where domain can be a single application 101, a group of applications, an organization, or a service provider.

In an exemplary embodiment, authentication server 108 is an LDAP server, used by application server 100 to authenticate users. In this exemplary embodiment, server 108 functions in accordance with Lightweight Directory Access Protocol (v3): Technical Specification. Request for Comments: 3377. The Internet Society. 2002. This RFC describes a directory access protocol that provides both read and update access. The LDAP model is one of clients performing protocol operations against servers. A client transmits a protocol request describing an operation to be performed to a server. The server is then responsible for performing the necessary operation(s) in a directory. Upon completion of the operation(s), the server returns a response containing any results or errors to the requesting client via protocol exchanges.

In accordance with an exemplary embodiment of the invention based on LDAP technology, bind request, bind response, bind redirect responses are examples of LDAPMessages 111, 112, 113, 114, 121, 122, 123, 124 which are encapsulated in protocol data unit (PDU) exchanges or operations, as set forth in Table 1.

TABLE 1
LDAPMessage Protocol Data Unit (PDU)

| LDAPMessage ::= SEQUENCE { | |
|---|---|
| messageID | MessageID, |
| protocolOp | CHOICE { |

| | |
|---|---|
| bindRequest | BindRequest, |
| bindResponse | BindResponse, |
| unbindRequest | UnbindRequest, |
| searchRequest | SearchRequest, |
| searchResEntry | SearchResultEntry, |
| searchResDone | SearchResultDone, |
| searchResRef | SearchResultReference, |
| modifyRequest | ModifyRequest, |
| modifyResponse | ModifyResponse, |
| addRequest | AddRequest, |
| addResponse | AddResponse, |
| delRequest | DelRequest, |
| delResponse | DelResponse, |
| modDNRequest | ModifyDNRequest, |
| modDNResponse | ModifyDNResponse, |
| compareRequest | CompareRequest, |
| compareResponse | CompareResponse, |
| abandonRequest | AbandonRequest, |
| extendedReq | ExtendedRequest, |
| extendedResp | ExtendedResponse }, |

controls [0] Controls OPTIONAL }
MessageID ::= INTEGER (0 .. maxInt)
maxInt INTEGER ::= 2147483647 -- (2\hat{ }\hat{ }31 − 1) −

Table 2 shows the format of LDAPResult 123, which is the response of LDAP server 108 to an LDAP client 104. One of the possible responses is “referral” (code 10) which is a synonym for “redirect”. See RFC2251.

TABLE 2
LDAPResult Format

| LDAPResult ::= SEQUENCE{ resultcode ENUMERATED { | |
|---|---|
| success | (0), |
| operationsError | (1), |
| protocolError | (2), |
| timeLimitExceeded | (3), |
| sizeLimitExceeded | (4), |
| compareFalse | (5), |
| compareTrue | (6), |
| authMethodNotSupported | (7), |
| strongAuthRequired | (8), |
| referral | (10), |
| adminLimitExceeded | (11), |
| unavailableCriticalExtension | (12), |
| confidentialityRequired | (13), |
| sslBindInProgress | (14), |
| noSuchAttribute | (16), |
| undefinedAttributeType | (17), |
| inappropriateMatching | (18), |
| constraintViolation | (19), |
| attributeOrValueExists | (20), |
| invalidAttributeSyntax | (21), |
| noSuchObject | (32), |
| aliasProblem | (33), |
| invalidDNSyntax | (34), |
| aliasDeferencingProblem | (36), |
| inappropriateAuthentication | (48), |
| invalidCredentials | (49), |
| insufficientAccessRights | (50), |
| busy | (51), |
| unavailable | (52), |
| unwillingToPerform | (53), |
| loopDetect | (54), |
| namingViolation | (64), |
| objectClassViolation | (65), |
| notAllowedOnNonLeaf | (66), |
| notAllowedOnRDN | (67), |
| entryAlreadyExists | (68), |
| objectClassModeProhibited | (69), |
| affectsMultipleDSAs | (71), |
| other | (80), |

| | |
|---|---|
| matchDN | LDAPDN, |
| errorMessage | LDAPString, |
| referral | (3) Referral OPTIONAL,} |

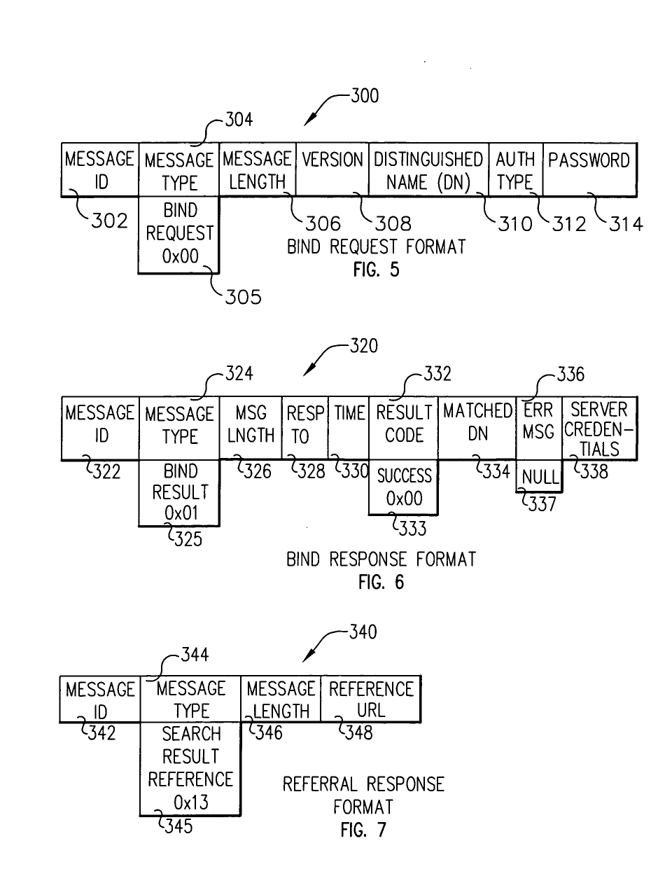

Referring to FIG. 5, the format of envelope 300 of an authentication (bind) request 111, 121, 122 includes message ID 302, message type 304 (which, for a bind request, is 0x00 305), message length 306, version, distinguished name (DN) 310, authentication type 312 and password 314 fields.

Referring to FIG. 6, the format of envelope 320 of an authentication (bind) response 114, 123, 124 includes message ID 322, message type 324 (0x01 for bind result), message length 326, respond to 328, time 330, result code 332 (0x00 for success 333), matched distinguished name 334, error message 336 (must be null 337) and server credentials 338 fields.

Referring to FIG. 6, the format of envelope 340 of a referral response 112 includes message ID 342, message type 344 (0x13 for search result reference) message length 346, and reference URL 348.

References to “bind” are for an LDAP exemplary embodiment. “Authentication” is a generic term encompassing “bind”.

The function of LDAPMessage envelopes 300, 320, 340 is to provide an envelope containing common fields required in all protocol exchanges.

All LDAPMessage envelopes 320 encapsulating responses 114, 123, 124, 112 contain the messageID value of the corresponding request LDAPMessage 113, 122, 121, 111, respectively.

A client application server 100 must not send a second request with the same message ID 302 as an earlier request on the same connection if the client has not received the final response from the earlier request. Otherwise the behavior is undefined. Typical clients increment a counter for each request.

Distinguished Name (LDAPDN) and Relative Distinguished Name (RelativeLDAPDN) are respectively defined to be the representation of a Distinguished Name and a Relative Distinguished Name after encoding such that

<distinguished-name> ::= <name>
<relative-distinguished-name> ::= <name-component>
LDAPDN ::= LDAPString
RelativeLDAPDN ::= LDAPString

Proxy authentication server 104 maintains history table 106 to track recent Authentication requests 121 submitted to server 108 by application server 100, which has been triggered by a login request 115 from client machine 110. Table 106 includes for each authentication request 121 user ID 131 and time of authentication request 133. Upon intercepting an authentication request 121, (such as an LDAP BIND request, or equivalent), proxy authentication server 104 determines whether to forward authentication request 121 as an authentication request 122 to server 108 based on a pre-defined filter rule or set of filtering rules 135 and the contents of authentication requests history table 106.

The function of the authentication operation is to allow authentication information to be exchanged between a client and a server.

Authentication Request 121, 122, for example in an LDAP embodiment, is defined as follows:

| BindRequest ::= [APPLICATION 0] SEQUENCE { | |
|---|---|
| version | INTEGER (1 .. 127), |
| name | LDAPDN, |
| authentication | AuthenticationChoice } |
| AuthenticationChoice ::= CHOICE { | |
| simple | [0] OCTET STRING, |
| | -- 1 and 2 reserved |
| sasl | [3] SaslCredentials } |
| SaslCredentials ::= SEQUENCE { | |
| mechanism | LDAPString, |
| credentials | OCTET STRING OPTIONAL } |

(SASL refers to a simple authentication and security
layer, a method for adding authentication support to
connection-based protocols.)

Parameters of the Bind Request are:

version 308: A version number indicating the version of the protocol to be used in this protocol session, such as version 3 of the LDAP protocol.

name 302: The name of the directory object that the client wishes to authenticate (bind) as. This field may take on a null value (a zero length string) for the purposes of anonymous authentications, when authentication has been performed at a lower layer, or when using SASL credentials with a mechanism that includes the LDAPDN in the credentials.

authentication 312, 314: information used to authenticate the name, if any, provided in the authentication request.

In accordance with the first exemplary embodiment, upon receipt of an authentication request 113, authentication (aka protocol) server 102 will authenticate the requesting client 110, if necessary. The server 102 will then return an authentication response 114 to client 100 indicating the status of the authentication.

Authorization is the use of this authentication information when performing operations. Authorization MAY be affected by factors outside of the authentication (such as LDAP Bind) request 111/121, such as lower layer security services. (See Lightweight Directory Access Protocol (v3). Request for Comments: 2251. The Internet Society (2002). At page 20.)

A filtering rule 135 may instruct proxy 104 to limit the number of authentication requests 111 and, consequently, login attempts 115 from client machine 110 for any given user ID 131 within a time frame specified in filter rules 135 by a given number as, for example “any user may not be allowed to login more than 10 times within any given 10-minute period.”

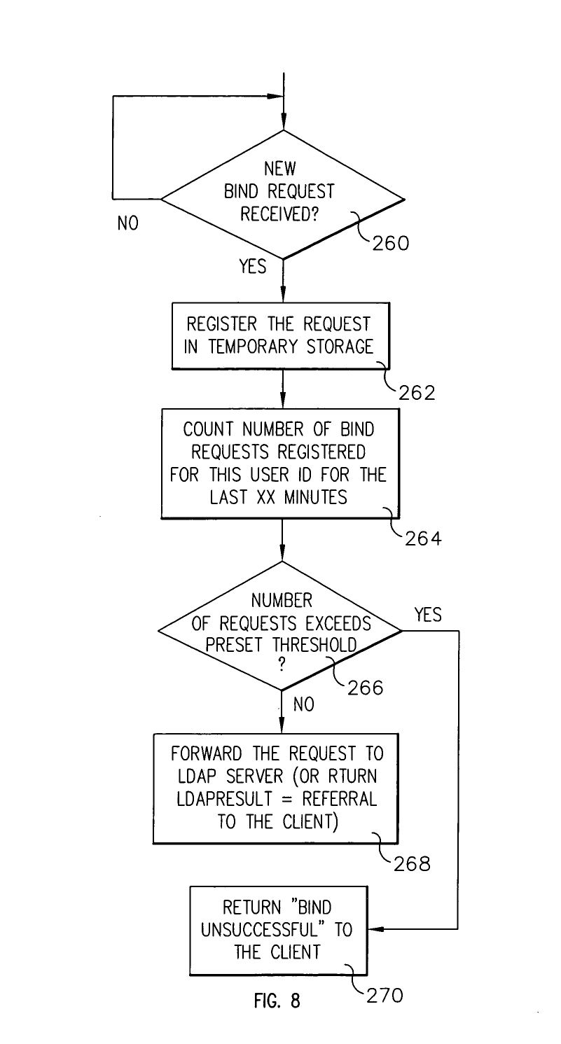

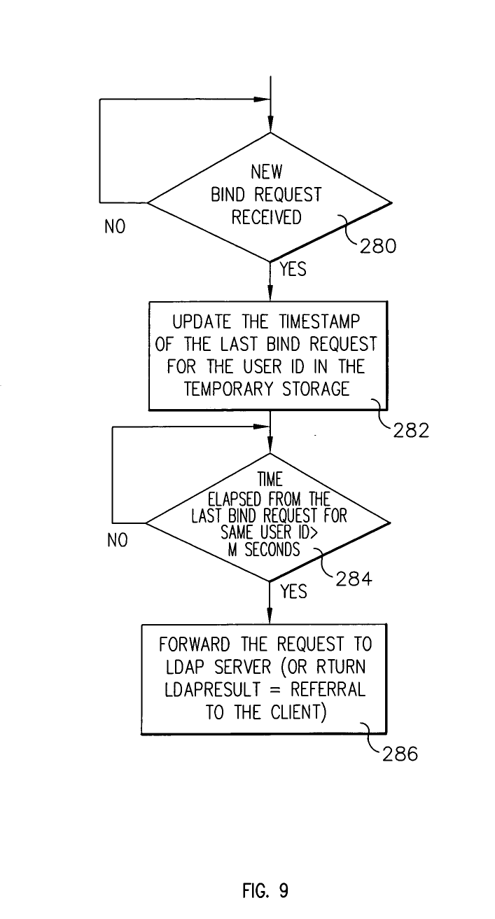

Referring to FIGS. 8 and 9, two exemplary filtering rules 135 are illustrated. The first filtering rule (FIG. 8) is: for any userID, the number of login attempts within any given XX minutes should not exceed N. The second filtering rule (FIG. 9) is: for any userID, the minimum time between two login attempts must be M seconds.

Referring to FIG. 8, a new bind request from a userID is received, and in step 262 registered in temporary storage. In step 264, the number of bind requests registered for this userID for the last XX minutes is counted, and in step 266 tested to see if a preset threshold has been exceeded. If so, in step 270 “bind unsuccessful” is returned to the client. If not, in step 268 in accordance with a first exemplary embodiment the request is forwarded to the LDAP server, and in accordance with a second exemplary embodiment “LDAPResult=referral” is returned to the client.

Referring to FIG. 9, a new bind request is received in step 280 and in step 282 the timestamp of the last bind request is updated for the userID of this bind request in temporary storage. In step 284 it is determined if the time elapsed from the last bind request for same userID is greater than M seconds and, if so, in step 286 in accordance with a first exemplary embodiment the request is forwarded to the LDAP server, or in accordance with a second exemplary embodiment “LDAPResult=referral” is returned to the client.

Referring further to FIG. 4, proxy authentication server 104 may forward requests 121 to authentication server 108 as a request 122 when timeout limiting the number of authentication requests by that user ID expires as is tracked in authentication request table 106.

If a new Authentication request 121 which satisfies filter rules 135 is received by proxy authentication server 104, it is forwarded to authentication server 108 as authentication request 122. Upon receiving authentication response 123 from authentication server 108, proxy authentication server 104 returns authentication response 123 to server 100 as authentication response 124.

Proxy authentication server 104 does not change the content of requests 111/121 and responses 112/124, and makes routing decisions only. Four situations are possible:
1. Send a given request 121 (as request 122) to authentication server 108 immediately (FIG. 4).
2. Send a given request 121 (as request 122) to authentication server 108 upon a timeout expiration, so that the filtering rule(s) 135 will be satisfied.
3. Return a “bind unsuccessful” response 124 to client 100 immediately.
4. Return a “redirect” response 112 to client 100 immediately.

Referring to FIG. 5, an authentication response 123, 124 (using LDAP bind as an example) may be structured as follows:

```
BindResponse ::= [APPLICATION 1] SEQUENCE {
    COMPONENTS OF LDAPResult,
    serverSas1Creds [7] OCTET STRING OPTIONAL
}”
```

An authentication response 123, 124 (such as a BindResponse) comprises an indication from the server of the status of the client's request for authentication. If authentication was successful, the resultcode will be success, otherwise it will be one of:
operationsError: server encountered an internal error,
protocolError: unrecognized version number or incorrect PDU structure,
authMethodNotSupported: unrecognized SASL mechanism name,
strongAuthRequired: the server requires authentication be performed with a SASL mechanism,
referral: this server cannot accept this authentication request and the client should try another,
saslBindInProgress: the server requires the client to send a new authentication request, with the same sasl mechanism, to continue the authentication process,
inappropriateAuthentication: the server requires the client which had attempted to authenticate anonymously or without supplying credentials to provide some form of credentials,
invalidcredentials: the wrong password was supplied or the SASL credentials could not be processed,
unavailable: the server is shutting down.

If the server does not support the client's requested protocol version, it sends the resultcode to protocolError.

If client 100 receives an authentication response, for example, an LDAP BindResponse response, where the resultCode was protocolError, it will close the connection as the server will be unwilling to accept further operations.

The serverSaslCreds are used as part of a SASL-defined bind mechanism to allow the client to authenticate the server to which it is communicating, or to perform “challenge-response” authentication. If the client bound with the password choice, or the SASL mechanism does not require the server to return information to the client, then this field is not included in the result.

(See Lightweight Directory Access protocol (v3). Request for Comments: 2251. The Internet Society (2002), at pages 20, 23.)

Referring to FIG. 3, proxy authentication server 104 will, upon determining that the filtering rule(s) 135 are immediately satisfied, or upon the expiration of the timeout limiting a number of authentication requests 111 by a given user ID 131 (also a rule in 135), return redirect response 112 to client application code 101, instructing it to send the authentication request 113 to authentication server 102, which will process the request and return authentication response 114.

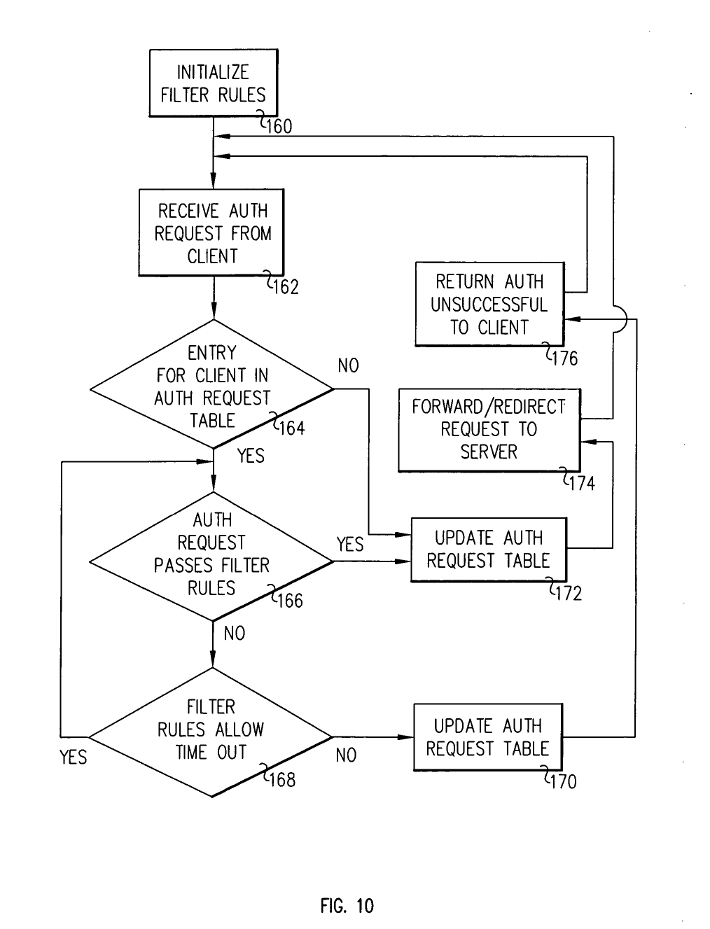

Referring to FIG. 10 in connection with FIGS. 3 and 4, DLAP proxy authentication server 104, in step 160, initializes filter rules table 135 (or, as represented in FIGS. 8 and 9, as processes). In step 162, proxy authentication server 104 receives an authentication request 111/121 from client 110 application server 100. In step 164 authentication request table 106 is accessed for user ID 131 corresponding to this client 110. If in step 164 no entry for this user ID 131 is found, in step 172, authentication request table 106 is updated for this request and in step 174 the request is forwarded 122 or redirected 112/113 to authentication server 102 (forwarded in the embodiment of FIG. 4 and redirected in the embodiment of FIG. 3) and proxy authentication server 104 returns to step 162 to await the next authentication request 111/121.

If, in step 164 it is determined that an entry for this client 100 exists in table 106, in step 166 proxy authentication server 104 determines if this request passes all relevant filter rules and rule sets. If so, processing continues to step 172 as above. If not, in step 168 if relevant filter rules and rule sets allow time out or expiration, processing cycles through step 166 until time out, and thereupon executes steps 172 and 174 as above. If relevant filter rules and rule sets 135 do not allow time out, in step 170 the authentication request table is updated for this request, authentication unsuccessful 124/112 is returned to client 110/application 100, and proxy authentication server 104 returns to step 162 to await the next authentication request 111.

When a rule 135 is not satisfied, proxy authentication server 104 can hold on to the response 124 and return response after time expires. Secondly, proxy authentication server 104 could return a rejection message 124 (in both cases FIG. 3 or FIG. 4: authentication unsuccessful.) A rule set is a number of such rules based on user primary group. For example, as in an LDAP model, every user has a primary group (such as, department).

### ADVANTAGES OVER THE PRIOR ART

It is an advantage of the invention that there is provided a system, method, or program storage device for protecting a server from denial of service attacks.

### Alternative Embodiments

It will be appreciated that, although specific embodiments of the invention have been described herein for purposes of illustration, various modifications may be made without departing from the spirit and scope of the invention. Referring to FIG. 11, in particular, it is within the scope of the invention to provide a computer program product or program element, or a program storage or memory device 150 such as a solid or fluid transmission medium, magnetic or optical wire, tape or disc, or the like, for storing signals readable by a machine as is illustrated by line 154, for controlling the operation of a computer 152 according to the method of the invention and/or to structure its components in accordance with the system of the invention.

Further, each step of the method may be executed on any general purpose computer, such as IBM Systems designated as zSeries, iSeries, xSeries, and pSeries, or the like and pursuant to one or more, or a part of one or more, program elements, modules or objects generated from any programming language, such as C++, Java, Pl/1, Fortran or the like. And still further, each said step, or a file or object or the like implementing each said step, may be executed by special purpose hardware or a circuit module designed for that purpose.

Accordingly, the scope of protection of this invention is limited only by the following claims and their equivalents.

We claim:

1. A method for protecting a server from denial of service attacks, comprising:
initializing in a proxy authentication server a set of one or more filter rules, said filter rules defining login frequencies permitted for specified classes of users;
maintaining in said proxy authentication server an authentication request table, said authentication request table including authentication tuples, each tuple including an authentication request user identifier and authentication request time for users submitting authentication requests;
receiving an authentication request from a client, said authentication request including a user identifier;
responsive to receiving said authentication request from a client, searching said authentication request table for tuples for said client;
responsive to finding one or more tuples for said client, applying said filter rules to said tuples;
responsive to said tuple failing a filter rule, rejecting said authentication request in a response message to said client server;
responsive to said tuple passing all relevant filter rules, directing said authentication request to an authentication server for authenticating said user.

2. The method of claim 1, responsive to said tuple passing all relevant filter rules, said proxy authentication server passing said authentication request directly to said authentication server, and receiving and passing directly to said client server an authentication response from said authentication server.

3. The method of claim 1, responsive to said tuple passing all relevant filter rules, said proxy authentication server returning to said client a redirect response for instructing said client to direct said authentication request to said authentication server.

4. The method of claim 1, at least one said filter rule specifying a time out value, said proxy authentication server responsive to an authentication request failing a filter rule with a time out value directing said authentication request to said authentication server upon expiration of said time out.

5. A program storage device readable by a machine, tangibly embodying a program of instructions executable by a machine to perform operations for protecting a server from denial of service attacks, said operations comprising:
initializing in a proxy authentication server a set of one or more filter rules, said filter rules defining login frequencies permitted for specified classes of users;
maintaining in said proxy authentication server an authentication request table, said authentication request table including authentication tuples, each tuple including an authentication request user identifier and authentication request time for users submitting authentication requests;
receiving an authentication request from a client, said authentication request including a user identifier;
responsive to receiving said authentication request from a client, searching said authentication request table for tuples for said client;
responsive to finding one or more tuples for said client, applying said filter rules to said tuples;
responsive to said tuple failing a filter rule, rejecting said authentication request in a response message to said client server;
responsive to said tuple passing all relevant filter rules, directing said authentication request to an authentication server for authenticating said user.

6. The program storage device of claim 5, said operations further including responsive to said tuple passing all relevant filter rules, said proxy authentication server passing said authentication request directly to said authentication server, and receiving and passing directly to said client server an authentication response from said authentication server.

7. The program storage device of claim 5, said operations further including responsive to said tuple passing all relevant filter rules, said proxy authentication server returning to said client a redirect response for instructing said client to direct said authentication request to said authentication server.

8. The program storage device of claim 5, at least one said filter rule specifying a time out value, said operations further comprising, responsive to an authentication request failing a filter rule with a time out value, directing said authentication request to said authentication server upon expiration of said time out.

9. A system for protecting a client application server from denial of service attacks, comprising:
a proxy authentication server for maintaining a set of one or more authentication rules and an authentication request table; said authentication request table including authentication tuples, each tuple including an authentication request user identifier and authentication request time for users submitting authentication requests; said filter rules defining login frequencies permitted for specified classes of users
an authentication server;
said client server responsive to an authentication request from a user including a user identifier for directing said authentication request to said proxy authentication server;
said proxy authentication server responsive to receiving said authentication request further for searching said authentication request table for tuples for said client; responsive to finding one or more tuples for said client, applying said filter rules to said tuples; responsive to said tuple failing a filter rule, rejecting said authentication request in a response message to said client server; and responsive to said tuple passing all relevant filter rules, directing said authentication request to an authentication server for authenticating said user.

10. The system of claim 9, said proxy authentication server, responsive to said tuple passing all relevant filter rules, further for passing said authentication request directly to said authentication server, and receiving and passing directly to said client server an authentication response from said authentication server.

11. The system of claim 9, said proxy authentication server, responsive to said tuple passing all relevant filter rules, further for returning to said client a redirect response for instructing said client to direct said authentication request to said authentication server.

12. The system of claim 9, at least one said filter rule specifying a time out value, said proxy authentication server responsive to an authentication request failing a filter rule with a time out value further for directing said authentication request to said authentication server upon expiration of said time out.

13. A program storage device readable by a machine, tangibly embodying a program of instructions executable by a machine to perform operations for protecting a server from denial of service attacks, said operations comprising
providing a proxy authentication server having an authentication request history table;
maintaining in said table recent authentication requests to a second server, including user ID and time of each of the recent authentication requests;
receiving a subsequent authentication request at said proxy authentication server; and determining whether to forward for authentication said subsequent authentication request to said second server based on a pre-defined filtering rule(s) and said user ID and time of authentication request in said authentication request history table.

14. A computer program product for protecting a server from denial of service attacks according to the method comprising:
providing a proxy authentication server having an authentication request history table;
maintaining in said table recent authentication requests to a second server, including user ID and time of each of the recent authentication requests;
receiving a subsequent authentication request at said proxy authentication server; and determining whether to forward for authentication said subsequent authentication request to said second server based on a pre-defined filtering rule(s) and said user ID and time of authentication request in said authentication request history table.
